(19) United States
(12) Patent Application Publication
(10) Pub. No.: US 2008/0280742 A1
(43) Pub. Date: Nov. 13, 2008

(54) THERMALLY INSULATING PAPERBOARD ARTICLE WITH HEAT-FOAMABLE COATING

(75) Inventor: Vincenzo S. Cerasani, Winnipeg (CA)

Correspondence Address: YOUNG & BASILE, P.C., 3001 WEST BIG BEAVER ROAD, SUITE 624, TROY, MI, 48084, US

(73) Assignee: M & N Plastics, Inc, Plant City, FL (US)

(21) Appl. No.: 11/747,897

(22) Filed: May 12, 2007

(51) Int. Cl. B65D 3/04; B31B 1/88

(52) U.S. Cl. 493/55; 229/403

(57) ABSTRACT

A thermally insulative paperboard sleeve for use in combination with hot and cold drink cups wherein the insulating quality is achieved by a layer of biodegradable, water-based, polymeric, heat-foamable material on at least the inside surface of the sleeve before it is assembled. Conventional graphics may be printed on the outside surface which remains smooth and receptive to conventional printing.

### FIELD OF THE INVENTION

This invention relates to thermally insulating sleeves made of paperboard and for use in combination with drink cups wherein the insulating quality is achieved by coating at least one side of the sleeve with a heat-foamable material.

### BACKGROUND OF THE INVENTION

A common problem associated with the services of hot and cold drinks is the transmission of thermal energy through the wall of the paperboard cup in which the drink is served. This problem is commonly solved by placing a thermally insulative sleeve around the outside of the cup. The consumer holds the cup with the sleeve between his hand and the outer surface of the cup. This can be an advantage with both hot and cold drinks.

### SUMMARY OF THE INVENTION

The present invention is a paperboard sleeve separate from but usable in combination with drink cups to place thermal insulation between the cup and the consumer. In general, this is accomplished by coating one or more surface of the sleeve with a heat-foamable, biodegradable material and heating the sleeve at some point in the manufacturing process to foam the material.

In one form, the article is a single-ply paperboard sleeve having a bonded seam, an inside surface and an outside surface. The heat foamable ink is printed on the inside surface of the sleeve before it is formed into a tapered cylinder and graphics are printed using conventional techniques on the outside surface for commercial purposes.

In other forms, the sleeve may comprise multiple paper layers with the foamed material between them. Also, the foamed coating may be applied to both inside and/or outside surfaces of the sleeve and may be patterned to create different effects. In all cases, the heat-foamable material is a biodegradable polymeric material such as acrylic latex in a water base.

### BRIEF DESCRIPTION OF THE DRAWING

FIG. 1 is a perspective view of a paperboard sleeve for use in combination with a paper up containing a hot liquid such as coffee showing the heat foamed insulating layer on the inside surface and a printed graphic on the outside surface;

FIG. 2 is a diagram of the basic steps of the method used to make the thermally insulated paperboard article shown in FIG. 1;

FIG. 3 is a perspective view of a multi-ply sleeve with the insulating foam between plies; and

FIG. 4 is a schematic view of a paperboard roll in the manufacturing process.

### DETAILED DESCRIPTION OF THE ILLUSTRATIVE EMBODIMENTS

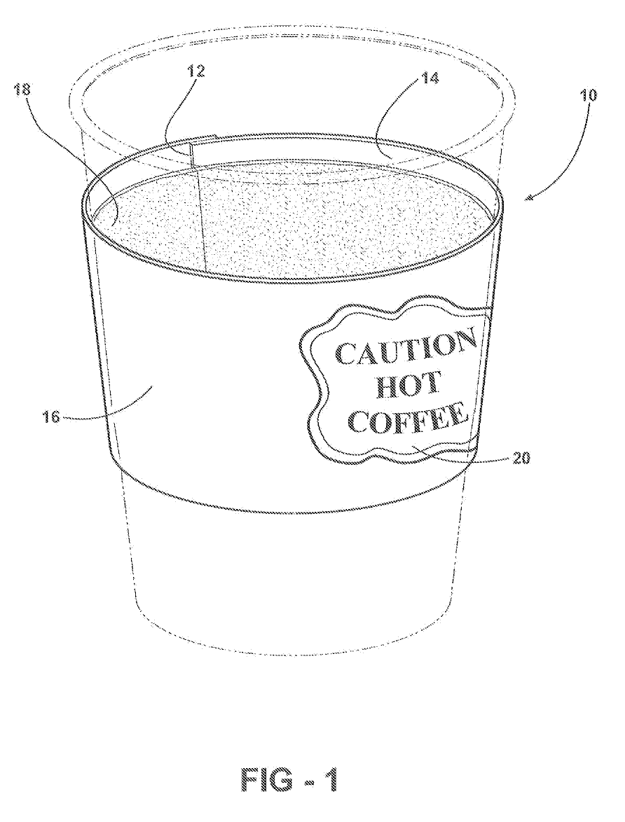

Referring to FIG. 1, a thermally insulative paperboard sleeve 10 made of paperboard and having an overlapping glue-bonded seam 12, an inside surface 14 and an outside surface 16 is shown. The sleeve 10 is slightly tapered to conform essentially to a conventional tapered paperboard hot drink cup shown in phantom lines at 17 such as dispensed in large numbers by so-called “fast food” restaurants, cafeterias, restaurants, convenience stores and service facilities of various other kinds.

A layer 18 of biodegradable, water based, heat-foamed ink is printed over the inside surface 14 before the sleeve 10 is assembled into the semi-cylindrical shape and is heated to foam the ink to provide air channels or pockets which afford the insulative quality. The term “ink” is used here to indicate that the material can be applied using techniques common to printing; it does not necessarily mean that the material 18 is pigmented. The heat-foamed ink 18 is printed on the portion of the surface which forms the overlapping glue-bonded seam 12 and may also be omitted from narrow bands adjacent the open top and bottom of the sleeve 10 in the assembled state. It will be understood from the following description that the application of the heat-foamable ink layer 18 is performed while the sleeve 10 is flat and, in the illustrative embodiment, while the sleeve is still part of a paperboard web 32 as hereinafter described, with reference to FIG. 4.

A graphic 20 i sprinted on the outside surface 16 using conventional printing techniques and non-foaming ink or inks for commercial purposes as will be well understood by those familiar with the manufacture of paperboard sleeves and cups. The graphic shown in FIG. 1 is purely illustrative.

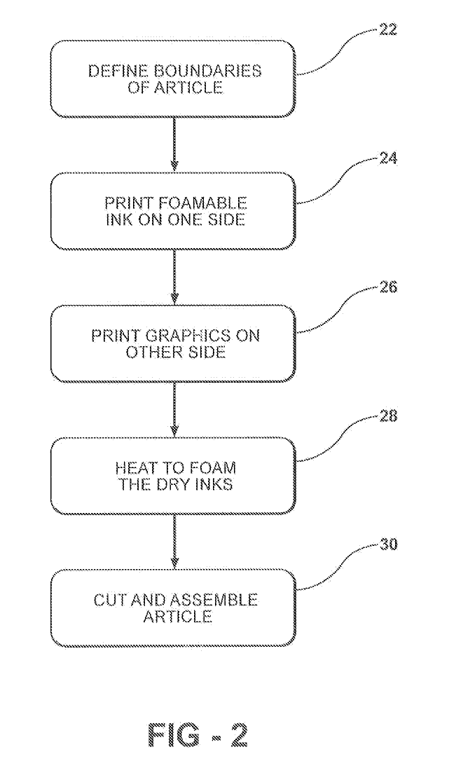

Referring to FIG. 2, the basic steps of illustrative method for making the insulative sleeve 10 in FIG. 1 will be descried.

Step 22 broadly includes defining the boundaries 34 of the paperboard sleeve 10 when it is part of a larger web 32 or strip of paperboard which can be fed through printing apparatus of conventional type as hereinafter described. The definition of the boundaries 34 of the article 10 may be done optically or electronically or with a combination of methods based on spacing and sizing of the article on a repeat basis in a web of paperboard from which the article 10 is later cut in multiples and assembled into the described shape. Again, this is given by way of illustration and does not limit the manufacturing method to a single-pass line; i.e., the various steps of the manufacturing method may be performed on different lines at different times.

After the boundaries 34 of the sleeve are defined in step 22, a heat foamable ink is printed using techniques such as flexography, rotogravure an screen printing on the surface 14 which is to become the inside surface of the sleeve 10.

Moving on to step 26, the graphics 20 are then printed on the surface 16 using one of the same types of printing technology described above. After steps 24 and 26, the article is then passed through an oven and/or heating rollers at step 28 to heat and foam the ink 18 and dry the ink used to create the graphics 20. This can be done on the press itself and before the sleeves 10 are removed from the web 32. In short, the steps 22, 24 26 and 28 may be performed in a continuous process involving a long strip 32 of paperboard of the desired weight as it moves through the machinery in which the steps are performed. Alternatively, the steps may be separately performed as described above.

Step 30 shows the final step of the manufacturing process which is to remove the article 10 by die-cutting from the web 32, form it into the described semi-cylindrical shape and bond the overlapping seam 12. As a person skilled in the manufacture of paperboard articles will appreciate, the articles may thereafter be placed in an appropriate shipping container and forwarded on to the end user.

A suitable heat-foamable coating material is available from Polytex Environmental, Inc. of New York, as well as other supplies. It is a water-base acrylic latex commonly used to create patterns on wall coverings.

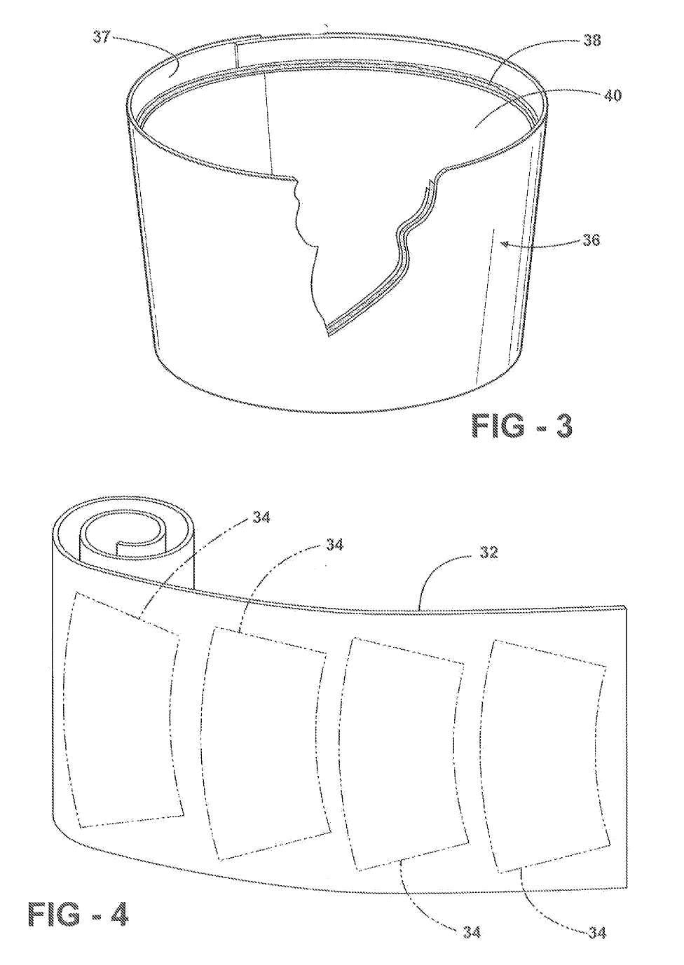

FIG. 3 shows an alternative embodiment in the form of a tapered sleeve 36 comprising a seamed outside paperboard layer 37, an intermediate foamed layer 38 and an inside paperboard layer 40. The outside layer is shown for purposes of illustration as having an overlapping seam while the inside layer 40 has a butt seam. The seams may both be butted on overlapped according to the wishes of the manufacturer.

There are a number of advantages deriving from the present invention. First, it has been found that biodegradable, heat foamable, water-based polymeric coating material provides insulation qualities which are superior to those of many of the prior art methods and is environmentally friendly. Second, the use of the heat-foamed material 18 actually fortifies the structural qualities of the paperboard and allows for the use of a lighter than normal gauge paper. This in turn produces the advantage of increased flexibility and grater conformity between the sleeve 10 an the underlying hot drink cup with which it is used. Finally, the reduction in the gauge of the paper results in reduced shipping weight which reduces the cost of transporting the article on mass to the end user.

Although specific embodiments have been illustrated and described herein, it will be appreciated by those of ordinary skill in the art that nay arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A paperboard sleeve with insulating quality comprising:
a substantially cylindrical body of paperboard having an inside surface and an outside surface; and
a layer of biodegradable, heat-foamed, polymeric material at least partially coating one of said surfaces.

2. The sleeve of claim 1 wherein the heat foamed material is one the inside surface.

3. The sleeve of claim 2 further including a graphic printed on the outside surface with non-foaming ink.

4. The sleeve of claim 1 wherein the body is in the shape of a tapered cylindrical sleeve with an open top and bottom.

5. A paperboard sleeve comprising:
(a) a generally cylindrical outer layer of paperboard;
(b) a generally cylindrical inner layer of paperboard; and
(c) a layer of biodegradable, heat-foamable material between the inner and outer layers, wherein all of the layers are part of a unitary article.

6. A method of making a thermally insulated paperboard article comprising the steps of:
(a) defining the boundaries of the article on a web of paperboard;
(b) printing biodegradable, heat-foamable ink on one side of the paperboard and within the boundaries of the article;
(c) heating the article to foam the ink; and
(d) removing the article from the web and assembling it into the desired shape.

7. The method defined in claim 6 further including a step of printing graphics on the side of the paperboard web opposite the side on which the foamable ink is printed such that the graphics are also within the boundaries of the article.

8. The method defined in claim 6 wherein the article, when assembled, is a substantially cylindrical sleeve.

9. The method defined in claim 7 wherein the article, when assembled, is a substantially cylindrical sleeve.
